(19) United States
(12) Patent Application Publication
(10) Pub. No.: US 2023/0075217 A1
(43) Pub. Date: Mar. 9, 2023

(54) METHOD FOR EVALUATION AND PAYOUT OF PARAMETRIC RISK-COVERAGE FOR HARD-TO-INSURE RISKS USING DISTRIBUTED LEDGER AND ASSOCIATED SYSTEM

(71) Applicant: Centinel Inc., South Barrington, IL (US)

(72) Inventor: Soton Rosanwo, South Barrington, IL (US)

(21) Appl. No.: 17/903,887

(22) Filed: Sep. 6, 2022

Related U.S. Application Data
(60) Provisional application No. 63/241,558, filed on Sep. 8, 2021.

(51) Int. Cl. G06Q 40/08; G06Q 40/04

(52) U.S. Cl. CPC G06Q 40/08; G06Q 40/04

(57) ABSTRACT

An evaluation and payout of parametric risk-coverage for hard-to-insure risks using a distributed ledger system is provided for evaluating, administering, and paying out claims relating to parametric risk-coverage using a distributed ledger to reduce and/or eliminate human operation and/or administration. A system to facilitate evaluation and payout of parametric risk-coverage for hard-to-insure risks using a distributed ledger may include a policy recommendation component, machine learning model, data verification and token generation component, distributed ledger, self-executing contract execution engine, payout component, incentivization token aspect, marketplace component, and social incentive component. A method for evaluating, administering, and paying out claims relating to parametric risk-coverage using a distributed ledger to reduce and/or eliminate human operation and/or administration using the evaluation and payout of parametric risk-coverage for hard-to-insure risks using a distributed ledger system is also provided.

### CROSS-REFERENCE TO RELATED APPLICATION

This application claims the priority from U.S. provisional patent application Ser. No. 63/241,558 filed Sep. 8, 2021. The foregoing application is incorporated in its entirety herein by reference.

### FIELD OF THE INVENTION

The present disclosure relates to an evaluation and payout of parametric risk-coverage for hard-to-insure risks using data storage structures, for example, distributed ledger technology. More particularly, the disclosure relates to evaluating, administering, predicting and defining losses, and paying out claims relating to parametric risk-coverage using a data storage structure, for example a distributed ledger, to reduce and/or eliminate human operation and/or administration.

### BACKGROUND

Insurance exists to mitigate financial damages from experiencing loss should an event associated with an insured risk occur. Traditional insurance policies can be classified in several types (e.g., Property & Casualty, Health, Life and Retirement, etc.) and can also be related to parametric risk-coverage policies. Parametric risk-coverage policies are based on conditions being met that are defined by certain parameters. If such conditions are met, for example from a trigger event occurring or experiencing a financial loss defined within a threshold by a policy, a payout may automatically be provided to the policyholder. However, both traditional insurance and parametric risk-coverage have long struggled to provide policies for high-risk categories, consumer policies, and other categories for which parametric risk-coverage have been difficult to apply. Additionally, administration of parametric policies has lacked a substantially automated, immutable, and authenticated platform to manage such policies. Furthermore, no known machine learning and artificial intelligence operations have been used to substantially automate at least part, if not substantially all, of the process of executing insurance or parametric risk-coverage policies in providing payouts upon the occurrence of a risk event.

Traditional insurance presents inefficiencies in the administration of policies, especially as the risks we face every day are becoming increasingly difficult to insure—from infectious disease and climate change to interrupted utilities and cancelled events. In fact, over 70% of people don't feel like they have adequate coverage for these risks, which cost US consumers over $500B a year. No known solution exists using parametric platforms, as most are highly focused on business-specific categories and weather-related risks. Additionally, no known insurance or parametric risk-coverage administration product or method is known to substantially automate giving back by leveraging a digital token that allows consumers to optionally allocate some of the profit from their policies to social incentives. No known insurance or parametric risk-coverage platform or method exists that may use digital tokens to compensate operators of nodes who help to secure a distributed ledger, which may be presented as an on-chain repository, as well as smart contracts stored by the distributed ledger. In addition, no known system or method is known that facilitates trading derivatives based on tokens relating to policies and/or buckets of policies categorized by riskiness.

Therefore, a need exists to solve the deficiencies present in the prior art. What is needed is a system and method to evaluate and cover hard-to-insure risks. What is needed is a method of analyzing hard-to-insure risks using machine learning to remove or reduce need for human interaction. What is needed is a method of managing data relating to policies, policyholders, and claims using a data storage structure, for example a distributed ledger such as may be provided via a blockchain. What is needed is a method and system for administering payouts of parametric risk-coverage claims substantially automatically, for example, via use of self-executing contracts such as smart contracts. What is needed is a method and system for creating marketable tokens associated with policies. What is needed is a method and system for promoting social incentives associated with parametric risk-coverage. What is needed is a method and system for trading tokens relating to risk-coverage in a virtual marketplace. What is needed is a method and platform to manage parametric risk-coverage using terms that are clear, transparent, and predictably executed.

### SUMMARY

An aspect of the disclosure advantageously provides a system and method to evaluate and cover hard-to-insure risks. An aspect of the disclosure advantageously provides a method of analyzing hard-to-insure risks using machine learning to remove or reduce need for human interaction. An aspect of the disclosure advantageously provides a method of managing data relating to policies, policyholders, and claims using a data storage structure, for example a distributed ledger such as may be provided via a blockchain. An aspect of the disclosure advantageously provides a method and system for administering payouts of parametric risk-coverage claims substantially automatically, for example, via use of self-executing contracts such as smart contracts. An aspect of the disclosure advantageously provides a method and system for creating marketable tokens associated with policies. An aspect of the disclosure advantageously provides a method and system for promoting social incentives associated with parametric risk-coverage. An aspect of the disclosure advantageously provides a method and system for trading tokens relating to risk-coverage and/or insurance in a virtual marketplace. An aspect of the disclosure advantageously provides a method and platform to manage parametric risk-coverage using terms that are clear, transparent, and predictably executed.

Accordingly, the disclosure may feature a method of administering a policy of parametric risk-coverage, the method being operable on a server storing user information about a user in an electronic computer database.

The method may include retrieving datasets via a computer communications network operatively connected to the server via a network connection, the datasets may include risk information relating to a risk that is coverable. The method may additionally include pricing a claim relating to the risk by analyzing the datasets to model a likelihood of a claim relating to the risk and determining a preliminary risk price for the risk based on at least the likelihood of a claim and a cost for the claim. The method may include defining triggers associated with the risk determinative of when a payout associated with the claim to which the triggers apply will be disbursed, the triggers being storable in a trigger catalogue.

The method may include recommending the policy for the risk. This may further include displaying on a user's remote computing device a survey regarding the risk for which the policy is requested. This may also further include comparing survey results from the survey with the risk information to determine if the risk is coverable. For the risk that is coverable, this may include adjusting the preliminary risk price to determine a policy risk price and recommending the policy at the policy risk price. In some embodiments, the method may include recommending coverage for detected risks that may be relevant to the user based on the user's individual characteristics (e.g., the user came seeking an interrupted utilities policy, but based on their geography the system recommends they also consider a climate change policy for hurricane-related risks), which may be offered to the user without requiring that the user specifically request such coverage determined to have relevance to the user.

The method may include establishing the policy, which may further include receiving via the computer communications network a selection by the user of the policy. For the policy selected by the user, this may include recording the policy to a distributed ledger and writing a smart contract to define the triggers that will cause the claim on the policy.

Additionally, the method may include monitoring for occurrence of the triggers defined by the self-executing contract such as a smart contract and, upon detection of the occurrence of the triggers, disbursing a payout. This may include substantially automatically executing the self-executing contract, substantially automatically disbursing funds for the payout defined by the smart contract to the user, and recording the disbursement to the data storage structure, for example, distributed ledger.

In another aspect, the datasets may include historical datasets and substantially real-time datasets.

In another aspect, the method may further include normalizing at least part of the datasets to promote comparative analysis of the risk information included in the datasets that are normalized and cleaning the datasets to generate a schema to assist with analyzing the datasets.

In another aspect, the method may further include generating data models using the schema and the datasets via a machine learning model and/or predictive analytics engine. The datasets may include historical datasets and substantially real-time datasets. Additionally, the data models may include a risk pricing model.

In another aspect, the method may include verifying the data models generated by the machine learning model and/or predictive analytics engine and validating at least the policy and the smart contract recorded to the data storage structure, for example, distributed ledger using nodes.

In another aspect, the method may include generating an incentivization token that may be associated with the policy and recorded to the data storage structure, for example, distributed ledger.

In another aspect, the method may include retrieving verification information via the computer communications network relating to the user. Using a trained machine learning model, the method may further include comparing the user information provided by the user with the verification information to determine a likelihood of verification of the user.

In another aspect, the data storage structure may be or include a distributed ledger, the self-executing contract may be or include a smart contract, and at least the policy and the smart contract are recorded to the distributed ledger and made immutable.

In another aspect, the method may include providing trading of derivatives relating to the policy and/or a bucket of policies comprising more than one policy via a marketplace. The bucket of policies may be represented by a utility token that is tradeable via the marketplace. Activity of the utility token that is traded may be recorded to the data storage structure, for example, distributed ledger.

In another aspect, the method may include selectively providing a beneficiary payout from at least part of the payout when elected by the user as social incentives. In this aspect, upon execution of the self-executing contract for the payout with the beneficiary payout being elected, at least part of the payout may be directed as the beneficiary payout. At least part of a remaining portion of the payout may be directed for disbursement to the user. In another aspect, the method may include selectively sharing at least part of the profits and/or proceeds on the premiums paid by the user for the risk-coverage, for example and without limitation, substantially automatically disbursing a portion of the profits to a designated beneficiary upon a determination by an operator of the method that a profit was earned from performing the method.

According to an embodiment enabled by this disclosure, a system is described to administer a policy of parametric risk-coverage. The system may include a server for storing user information about a user in an electronic computer database. The system may also include a network connection from the server to a computer communications network. The server may be configured to execute instructions.

The system may perform retrieving datasets via the computer communications network comprising risk information relating to a risk that is coverable. The system may perform pricing a claim relating to the risk by analyzing the datasets via the server to model a likelihood of claim relating to the risk and determining a preliminary risk price for the risk based on at least the likelihood of claim and a cost for the claim. The system may perform defining triggers associated with the risk determinative of when a payout associated with the claim to which the triggers apply will be disbursed.

The system may perform recommending the policy for the risk. For example, the system may perform displaying on a user's remote computing device a survey regarding the risk for which the policy is requested, comparing survey results from the survey with the risk information to determine if the risk is coverable, for the risk that is coverable, adjusting the preliminary risk price to determine a policy risk price and recommending the policy at the policy risk price.

The system may establish the policy, which may include receiving via the computer communications network a selection by the user of the policy, recording the policy selected by the user to a data storage structure, and writing a self-executing contract to define the triggers that will cause the claim on the policy. The system may monitor for occurrence of the triggers defined by the self-executing contract and, upon detection of the occurrence of the triggers, disbursing a payout by performing the steps of substantially automatically executing the self-executing contract, substantially automatically disbursing funds for the payout defined by the self-executing contract to the user, and recording the disbursement to the data storage structure.

In another aspect, the datasets may include historical datasets and substantially real-time datasets.

In another aspect, at least part of the datasets may be normalized to promote comparative analysis of the risk information included in the datasets that are normalized. Additionally, the datasets may undergo cleaning to generate a schema to assist with analyzing the datasets.

In another aspect, a machine learning model and/or predictive analytics engine may be provided to generate data models using the schema and the datasets. The datasets may include historical datasets and substantially real-time datasets. The data models may include a risk pricing model.

In another aspect, nodes may be provided to verify the data models generated by the machine learning model and/or predictive analytics engine and validate at least the policy and the self-executing contract recorded to the data storage structure.

In another aspect, an incentivization token may be generated and associated with the policy recorded to the data storage structure.

In another aspect, a trigger catalogue stored in the electronic computer database and accessible by the server may be provided to store the triggers.

In another aspect, the data storage structure may be or include a distributed ledger, the self-executing contract may be or include a smart contract, and at least the policy and the smart contract are recorded to the distributed ledger and made immutable.

In another aspect, a marketplace component may be included that provides trading of derivatives relating to the policy and/or a bucket of policies comprising more than one policy. The bucket of policies may be represented by a utility token that is tradeable via the marketplace component. Activity of the utility token that is traded may be recorded to the data storage structure.

In another aspect, a social incentives component may be provided that selectively makes a beneficiary payout from at least part of the payout when elected by the user. In this aspect, execution of the smart contract for the payout with the beneficiary payout being elected may direct at least part of the payout as the beneficiary payout and may direct at least part of a remaining portion of the payout as disbursement to the user. In another aspect, a social incentives component may be provided that selectively provides a profits payout from at least part of profits, selectively directs at least part of the profits payout as a beneficiary payout as defined by the user, and disburses the remaining portion of the profits payout to the user or retained by an operator of the system.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of a high-level system enabled by this disclosure, according to an embodiment of this disclosure.

FIG. 2 is a block diagram view of an illustrative policy recommendation component, according to an embodiment of this disclosure.

FIG. 3 is a block diagram view of an illustrative data verification and token generation component, according to an embodiment of this disclosure.

FIG. 4 is a block diagram view of an illustrative payout component, according to an embodiment of this disclosure.

FIG. 5 is a block diagram view of an illustrative incentivization and marketplace component, according to an embodiment of this disclosure.

FIG. 6 is a block diagram view of a computerized device on which at least part of a system and method enabled by this disclosure is operable, according to an embodiment of this disclosure.

FIG. 7 is a flowchart view of an overview of the evaluation, management, administration, payout, and other operations, according to an embodiment of this disclosure.

FIG. 8 is a flowchart view of an illustrative policy recommendation and generation operation, according to an embodiment of this disclosure.

FIG. 9 is a flowchart view of an illustrative verification and token generation operation, according to an embodiment of this disclosure.

FIG. 10 is a flowchart view of an illustrative payout operation, according to an embodiment of this disclosure.

FIG. 11 is a flowchart view of an illustrative social incentive with profit sharing operation, according to an embodiment of this disclosure.

### DETAILED DESCRIPTION

The following disclosure is provided to describe various embodiments of an evaluation and payout of parametric risk-coverage for hard-to-insure risks using a data storage structure system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term parametric risk-coverage, as it is used throughout this disclosure, is defined as a risk-management product that executes a payout based on triggers or the occurrence of a risk event, which may include an event that occurs relating to a risk and the detection of trigger parameters being met or exceeded. In some deployments, triggers may occur in a binary structure, with triggers being engaged upon passing a threshold amount or affirmatively meeting a condition set by a parameter. In some embodiments, multiple triggers may be defined, wherein each of the multiple triggers may need to be detected to initiate a payout on the policy.

The term policy, as it is used throughout this disclosure, is defined as risk coverage provided to a policyholder and the terms and conditions governing same. The term policyholder, as it is used throughout this disclosure, is defined as a customer or other user that holds and/or is taking steps to hold a risk-coverage policy, such as one provided by the methods and system enabled throughout this disclosure. The term user, as it is used throughout this disclosure, is defined as a person or entity that interacts with a method and system enabled by this disclosure, which includes policyholders.

The term data storage structure, as it is used throughout this disclosure, is defined as a collection of data organized such to facilitate storage, organization, modification, manipulation, transmission, and other interactions with the data stored by the data storage structure. In some embodiments, the data storage structure comprises distributed ledgers, localized databases, repositories, cloud-based platforms, and/or additional data storage structures that would be appreciated those of skill in the art. The term distributed ledger, as it is used throughout this disclosure, is defined as decentralized, replicated, shared, and validated data structures that record information, transactions, rights, and other data in a substantially immutable form. Distributed ledgers may be included as part of a blockchain, may be validated by nodes of computational devices on a network, and may be configured to operate without a central authority. Distributed ledgers may be associated with public blockchains and ledgers, Ethereum, private blockchains and ledgers, Hyperledger, multiple ledgers, and/or other configurations that would be apparent to those of skill in the art. Uses of alternative terms for a distributed ledger, such as blockchain, chain, on-chain repository, and other similar terms may be used throughout this disclosure and without limitation. The term self-executing contract, as it is used throughout this disclosure, is defined as an agreement of terms intended to substantially automatically execute upon the detection of a trigger and/or satisfaction of a condition relating to the self-executing contract. The term smart contract, as it is used throughout this disclosure, is defined as a self-executing contract that is associable with a distributed ledger, wherein terms and triggers relating to the smart contract may be stored via the distributed ledger.

Various aspects of the present disclosure will now be described in detail, without limitation. In the following disclosure, an evaluation and payout of parametric risk-coverage for hard-to-insure risks system will be discussed. Those of skill in the art will appreciate alternative labeling of the evaluation and payout of parametric risk-coverage for hard-to-insure risks system as a parametric platform for claims-free coverage for hard-to-insure risks, substantially automated parametric risk-coverage system, risk-coverage system using distributed ledgers to evaluate risk and administer payout using smart contracts, machine learning parametric risk-coverage platform, the invention, or other similar names. Similarly, those of skill in the art will appreciate alternative labeling of the method of evaluation and payout of parametric risk-coverage for hard-to-insure risks as a method of administering claims-free parametric coverage for hard-to-insure risks, method of managing and administering risk-coverage claims using machine learning and distributed ledgers, method of determining risk-coverage events and administering payouts using smart contracts, method, operation, the invention, or other similar names. Skilled readers should not view the inclusion of any alternative labels as limiting in any way.

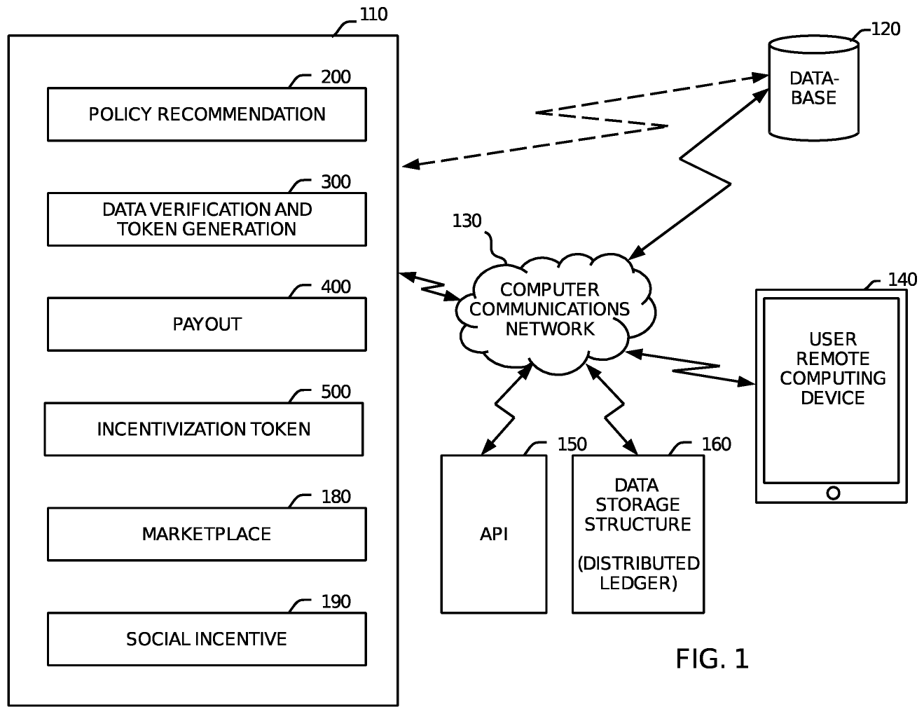

Referring now to FIGS. 1-11, the evaluation and payout of parametric risk-coverage for hard-to-insure risks using a data storage system, for example a distributed ledger system, will now be discussed in more detail. The evaluation and payout of parametric risk-coverage for hard-to-insure risks system may include and/or be communicably connected to a server that includes a policy recommendation component, machine learning engine, data verification and token generation component, self-executing contract, payout component, incentivization token aspect, marketplace component, social incentive component, and additional components that will be discussed in greater detail below. The evaluation and payout of parametric risk-coverage for hard-to-insure risks system may operate one or more of these components interactively with other components for evaluating, administering, and paying out claims relating to parametric risk-coverage using a data storage structure, for example a distributed ledger, to reduce and/or eliminate human operation and/or administration.

In one example configuration, a system enabled by this disclosure may include a server 110 communicably connected to other elements via a computer communications network 130. The sever 110 may include various components, engines, aspects, and other operations to facilitate executing instructions to provide functionality that will be described in greater detail below, including execution of machine learning aspects, artificial intelligence, management of distributed ledgers and/or blockchains, and other operations that will become apparent throughout this disclosure. Illustrative components and other features of a server 110 may include a policy recommendation component 200, data verification and token generation component 300, payout component 400, incentivization token aspect 500, marketplace component 180, social incentive component 190, and/or other components and other features, without limitation.

A database 120 may be used to exchange data with the server 110, store data from the server 110, and otherwise provide information that may be used in the operation of methods and a system enabled by this disclosure. The database 120 may be connected directly to the server 110 in some embodiments. In other embodiments, the database 120 may be communicably connected to the server 110 via a computer communications network 130. Multiple databases 120 may be communicably connected to the server 110 without limitation, for example, historical databases, real-time databases, ID databases, and/or other database types that would be apparent to a person of skill in the art after having the benefit of this disclosure.

Additional features may be communicably connected to the server 110 and/or database 120 via the computer communications network 130. For example, external computer systems and data sources may use an application programming interface (API) 150 to send and receive requests for information and return the information being requested. Also, a distributed ledger or other data storage structure 160 may be communicably connected to the server 110 and/or other components via a computer communications network 130. Furthermore, a user remote computing device 140 may be accessible by a user to interact with features provided by the server 110, data included by one or more databases 120, information accessible via an API 150, and/or other information that may relate to the operation of a system and method enabled by this disclosure. These features will be discussed in greater detail throughout this disclosure.

The policy recommendation component will now be discussed in greater detail. FIGS. 1-2 and 7-8 highlight examples of the policy recommendation component, which may also be shown in other figures. The policy recommendation component 200 may assist with identifying risk, pricing risk, defining triggers, matching policies with policyholders, recommending policies, and/or other activities that may relate to the determination of a policy recommendation and creation of a policy. The server 110 may request, receive, and/or provide information to one or more connected database 120, for example, databases that include information about conditions from a historical and/or substantially real-time content. Historical datasets may be used in the operation of a policy recommendation component 200 to identify risk, define triggers, and correlate such risks and triggers with information provided by a policyholder and/or other user.

An illustrative policy recommendation component 200 may assist with pricing identified risks. The policy recommendation component 200 may request information from the connected databases 120, for example historical databases and/or substantially real-time databases. The requested information may be analyzed by the server 110 to detect trends, probabilities, and other information suggesting the occurrence of a risk event, satisfaction of a trigger, and/or other condition that may initiate a claim that may result in the execution of a self-executing contract, such as a smart contract, associated with a policy that may require a payout to a policyholder. In some embodiments, the analysis of the requested information by the server 110 may advantageously use artificial intelligence and/or machine learning tools. One or more of these analyses and predictions may be assisted by machine learning, which may be trained using information about past successful predictions, unsuccessful predictions, historical trends, and/or other information that may be indicative as to the accuracy of prior predictions and adjustments that may improve such accuracy.

To assist the server 110 with identifying risks and pricing policies accordingly, information may be transmitted from the server 110 to one or more external databases 120, for example, as part of a request for responsive information. Such information may include the location of a potential policyholder, historical weather events relating to such location, trending prevalence of infectious diseases, uptime of utility networks, and/or other information that would be apparent to those of skill in the art after having the benefit of this disclosure. Custodians of the databases 120 receiving the request may include information relevant to the request, which may be provided to the server 110 in response to the request. Database custodians may provide information relevant to the parameters included in the data request, for example, including details such as given in the examples above. In some embodiments, commercial relationships may be established with custodians of various databases 120 to grant information requests and provide contents of the information that may be used to price identified risks and predict whether a trigger is likely to occur relating to such risks. At least some of this information may be used to determine a preliminary risk price for a prospective policy that may cover claims relating to the risk event associated with the information.

In one example, provided without limitation, a request may be made to a distributed ledger or other data storage structure 160, such as one using distributed ledger technology (DLT), for information stored by the distributed ledger or other data storage structure 160. Data may be stored on a distributed ledger or other data storage structure 160, which may be verified by nodes to provide substantial immutability and high resistance to unauthorized manipulation of such data. Data may be encrypted by the server 110, on the database 120, on the distributed ledger or other data storage structure 160, and/or elsewhere as would be understood by skilled artisans. Data included on the distributed ledger or other data storage structure 160 may be stored in a zero-knowledge format and may benefit from homomorphic encryption usable when querying encrypted data.

Analysis of the information discussed above may be used to produce a data model, for example, a risk pricing model. Example risk pricing models may include considerations based on analysis of historical data, such as and without limitation, when risk events occur, where risk events occur, what kind of risk event has occurred, trends, and/or other historical data that may indicate the likelihood that a risk event my occur. Additionally, in at least some embodiments, substantially real-time data may be used to adjust the risk pricing model. In some embodiments, artificial intelligence and/or machine learning may assist with the determination and production of a risk pricing model. For example, provided without limitation, a feedback loop may be provided to an artificial intelligence and/or machine learning model to adjust the risk pricing model to increase prices if loss ratios are trending too high, decrease prices if the pricing model is trending as too profitable, and/or otherwise adjust the risk pricing model to reflect trends and/or conditions detected via a feedback loop.

In some embodiments, referencing the risk pricing model may assist with establishing a reserve amount of paid premiums to secure the potential for payouts to policyholders in the event of a trigger occurring. In some embodiments, determination of a satisfactory reserve amount may be assisted by artificial intelligence and/or machine learning models that may be trained by a feedback loop such as discussed in the examples throughout this disclosure. In another embodiment, a prediction of adequate reinsurance policies may be determined by similar analysis of the risk pricing model, machine learning model, and/or other predictive operations discussed throughout this disclosure.

In some embodiments, a risk pricing model may be tailored to a policyholder and/or other user. At least part of the risk pricing model may be generalized, for example, for such aspects that may relate to a geographic location, which may be used to generate the preliminary risk price for claims that may relate to a category of coverable risks. The preliminary risk price may provide a pricing baseline for policy types, which may be adjusted to consider particular conditions relating to a policyholder or risk to be covered. Adjustment of the objective preliminary risk price may be used to produce a policy risk price, which may reflect the subjective price of a requested policy. In some embodiments, at least part of the risk pricing model may be stored on a database 120 directly and/or communicably connected to the server 110 and accessible by the server 110.

The server 110 may additionally define triggers, which may use information from historical datasets, substantially real-time datasets, and/or other datasets to determine whether an event has occurred. Triggers may relate to conditions that, upon being met, indicate that a policy requirement has been fulfilled and a payout may be required. Triggers may be mapped to identify the risks, such as those included by a policy. Triggers may be stored in a database 120 directly and/or communicably connected to the server 110. Multiple triggers may be stored in a trigger catalog, which may be stored in one more database 120. In another embodiment, triggers and/or trigger catalogs may be at least partially stored on a distributed ledger or other data storage structure 160 and/or other data storage structure.

Example triggers will now be discussed, without limitation, to illustrate some possible events that may result in a claim and/or payout to a policyholder. In an example of a policy covering contraction of infectious diseases, triggers may include positive lab results indicating infection with a covered disease, lapse of employment due to illness relating to a covered disease, death certificates, medical records, patient discharge notices, prescription fulfillments, and/or other similar information. In an example of a policy covering a flooding event, triggers may include rainfall duration, rainfall intensity, water levels of nearby rivers and other bodies of water, elevation, zip code, distance from a shore, date of weather events, and/or other information relating to a flooding event. In an example relating to interruption of utilities, triggers may include utility-reported down time, duration of utility interruption, zip code, utility service address, reports from other utility customers, and/or other information that may relate to the interruption of utilities. In an example relating to event cancellation policies, triggers may include weather events, snowfall, date, time, duration, zip code, whether an event is conducted indoors or outdoors, event cancellation by administrators of the event, event type, and/or other information that may relate to an event.

In some embodiments, multiple triggers may be defined, wherein each of the multiple triggers may need to be detected to initiate a payout on the policy. In some embodiments, a partial payout may occur upon detection of at least some, but not all, of the triggers being detected. Embodiments including partial payout may offer such coverage for a policy as an addon, for example, with an adjustment to premiums to cover inclusion of partial payout in the policy.

The policy recommendation component 200 may include surveys shared with policyholders and/or other users to assist in determining a risk profile relating to a requested policy. The survey may also reference claims history of existing and/or past policyholders. For example, a server 110 may communicate to a policyholder and/or other user a list of questions and requests for information relating to a desired risk-coverage policy. Such information may include the property to be covered, location of such property, claim history, desired coverage amount, coverage duration, desired premium, and/or other information that may assist in predicting a policy to recommend to a policyholder and/or other user. The policyholder and/or other user may receive the survey on their user remote computing device 140, which may be communicably connected to the server via a computer communications network 130.

An illustrative survey will now be discussed, without limitation. The survey may include questions that may assist in predicting a likelihood of a claim based on whether a trigger is likely to occur relative to a risk. Illustrative questions may include identifying information, claim history, policyholder location, policy coverage amounts, ability to pay policy premiums, size of home, employment history, and/or other information that may facilitate determining a policy that may best match the needs of a policyholder.

Information provided by a policyholder, such as being provided through a survey, may be compared by the server 110 to information retrieved from one or more databases used to determine and/or price risk. The server 110 may determine a likelihood of a claim being made on a policy, for example, due to a trigger event occurring. Upon making the determination, a server 110 may use machine learning to leverage historical information to improve its prediction abilities. Information relating to past predictions may be used to train the machine learning model to improve the ability to match a risk profile, included triggers, and survey information to predict the likelihood that a claim will be made on the policy. Pricing information in the risk pricing model may be adjusted as the machine learning model improves its prediction capabilities. The server 110 may use the risk pricing model, survey results, and/or other information to adjust the objective preliminary risk price to a policy risk price associated with a policyholder and/or other user subjective needs and likelihood of a claim being triggered.

After analyzing the information, the server 110 may suggest a policy to a policyholder at the policy risk price that is predicted to match the policyholders balance of risk aversion, ability to pay premiums, likelihood of a trigger being met, and other factors that may contribute to matching a policy with a policyholder. Such recommendations to a policyholder may be stored in a database 120, which may be connected directly and/or communicably to the server 110 and accessible by the policy recommendation component 200 of the server 110 to assist with future predictions and/or training of the machine learning model.

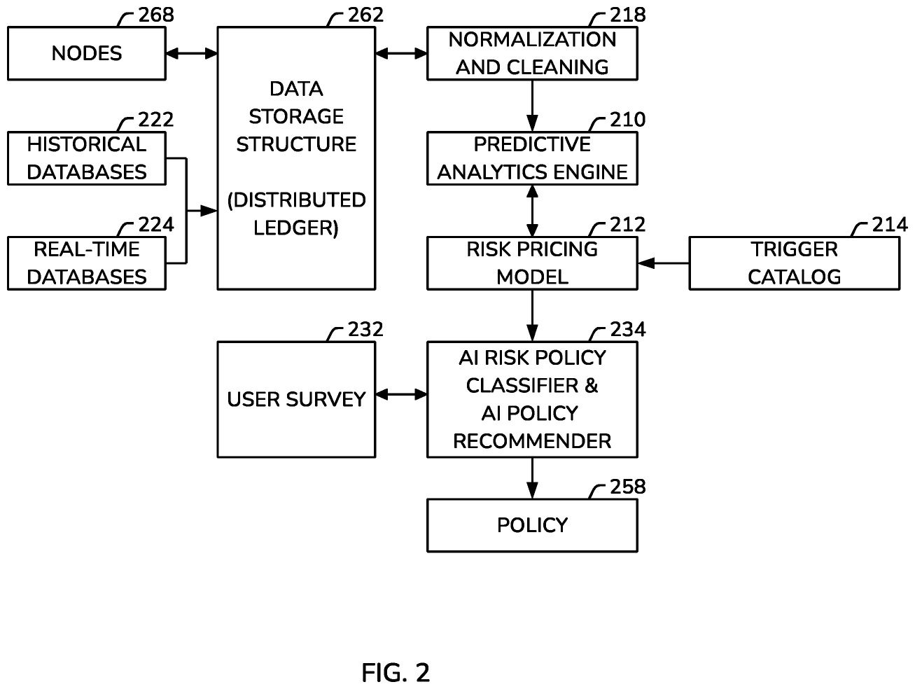

Referring now to FIG. 2, an illustrative policy recommendation component will now be discussed, without limitation. In this illustrative policy recommendation component, a data storage structure 262, for example a distributed ledger, may be provided to hold information relating to a policyholder, policy, and/or other aspects of a coverable risk. The information may be stored using a distributed ledger, on-chain repository, and/or other cloud platform. Data included by the data storage structure 262, for example a distributed ledger, may be validated using nodes 268, which may be operated by third parties and/or others to provide computational resources that may be used to verify contents of the data storage structure 262 in exchange for credit or other financial incentives. In another embodiment, at least part of the nodes 268 may be provided by a proprietary source and/or operator of the data storage structure 262, for example a distributed ledger.

One and more databases may be communicably connected to the data storage structure 262, for example a distributed ledger, through which information may be provided to a record held by the data storage structure 262. Such databases may include historical databases 222, substantially real-time databases 224, and/or other databases that would be apparent to those of skill in the art after having the benefit of this disclosure. Data received by the data storage structure 262 may undergo normalization and cleaning 218. Normalization may include adjustment of data to align with other types of data such that comparative analysis may be made and correlations may be determined. Data may be organized into a table structure to facilitate consistent handling of data received via databases, for example using an API, to ensure consistency that is agnostic of the source format. Cleaning may include formatting the data such that it is presented in a consistent and readable format by other aspects of a system enable by this disclosure. In some examples, a flag may be created and/or enabled upon determination that an error has occurred in normalizing, cleaning, or otherwise handling data and other information. Data that has been normalized and cleaned may be communicated from the normalization and cleaning element 218 to the data storage structure 262, for example to a distributed ledger, to be stored in its usable format.

A predictive analytics engine 210 may receive normalized and cleaned data from the normalization and cleaning element 218, on which predictive analytics may be performed. An output from the predictive analytics engine 210 may be provided to a risk pricing model 212, which may predict a price to match a risk profile provided by the predictive analytics engine 210. At least part of the data that has been normalized and cleaned may be used to share information with a user, for example, via an analytics dashboard. Additionally, triggers may be provided to the risk pricing model from a trigger catalog 214. Information in the risk pricing model 212 may be provided back to the predictive analytics engine 210 to improve the analytics of the data and predictions based on such analytics.

A risk policy classifier and policy recommender 234 may receive information from the risk pricing model 212, user surveys 232, and/or other sources to classify and predict policies undergoing the analysis. The risk policy classifier and policy recommender 234 may use artificial intelligence and/or machine learning to assist with classification and policy recommendation. At least part of the questions provided to a policyholder via user surveys 232 may be provided and/or suggested by the risk policy classifier and policy recommender 234. Once the risk policy classifier and policy recommender 234 has finished classifying the policy and has prepared a recommendation, a policy 258 may be prepared and recommended to a policyholder. The policyholder may accept the recommendation or select a different policy configuration. The policy selected by the policyholder may then be stored by the data storage structure 262 and a self-executing contract for the policy being created. For example, the policy selected by the policyholder may then be stored via a distributed ledger and a smart contract for the policy may be written.

The data verification and token generation component will now be discussed in greater detail. FIGS. 1-4 and 6-9 highlight examples of the data verification and token generation component, which may also be shown in other figures. Information provided by a user may need to be validated before it can be used for risk pricing, authentication, and policy writing purposes. Information relating to the policyholder may be analyzed by an aspect of the server 110, for example a date of verification and token generation component 300, to determine a likelihood of verification of the identity of the policyholder and/or other user requesting a policy. Verified information relating to a policyholder and/or other user may be held in a policyholder ID token, which may be established by operation of the server 110 performing a method enabled by this disclosure. Policyholder information may be verified using one or more data sources, for example a self-sovereign identity register, governmental databases, commercial databases, public information, private information, and/or other sources that may include information indicative of a verified identity of a user. In some embodiments, users having a likelihood of verification indicative of being unable to verify an identity may be declined coverage.

In one embodiment, a self-sovereign identity associated with a policyholder may be used to validate information relating to the policyholder. For example, information relating to a policyholder and/or other user may be stored in a data location, for example a distributed ledger or other data storage structure 160, that may be used to verify information relating to the user without being required to disclose more information than necessary about that user. For example, verification may request whether a prospective policyholder is within the age group of 35 and older. Using a self-sovereign identity verification check, a verified result may return an affirmative answer without disclosing the actual age of the perspective policyholder. Similar checks may be performed for credit rating, income, past claims, and other information that may be relevant to risk pricing, insurability, and policy recommendation terms.

In another example, information may be retrieved from one or more data sources that may contain information relating to the user undergoing verification. For example, public databases may include information relating to purchase of a property that may be subject to a risk-coverage policy, address, location, age, relationships, and other information that may be publicly shared. In another example, governmental databases may be used to provide information regarding marriage licenses, deed recordings, assigned credentials, professional licenses, tax filings, criminal records, and/or other information that may be retrieved from governmental databases. In a further example, information may be provided from private data sources, such as may be sourced from utility services, data brokers, private businesses, and/or other data sources to which access may be granted to retrieve such information. In some cases, relationships may be established with utility providers and/or other data sources granting access to information regarding policyholders and/or other users. In some examples, consent may be requested and/or required before data may be retrieved from a connected data source. At least part of the data retrieved may be cached in a local database and/or other data storage location that may be directly and/or communicably connected to the server 100, such as via a computer communications network 130.

A policyholder may use a digital identity wallet to hold the verifying information relating to that user. The policyholder may scan identification documents and/or credentials, for example professional licenses, identity ID cards, passport, and/or other information to be associated with the policyholder. Requests to external sources for information that may be used to verify the identity of a policyholder may be requested via an API, and receipt of such information may be in response to such an API request. A machine learning model may be applied to assist with correlating information provided by a policyholder with the information retrieved from external sources, which may assist with validating the authenticity of a policyholder and/or contents of that policyholder's digital identity wallet.

Upon verification that a policyholder identity is valid, a token may be generated to represent the policyholder. The token may be stored digitally on a distributed ledger or other data storage structure 160, from which other aspects of a system enabled by this disclosure may retrieve information provided through the token and perform operations in a substantially automated form using information associated with the token.

The policyholder may keep a copy of their digital policyholder token on their user remote computing device 140 and/or another device. A copy of the policyholder token may additionally be stored on the distributed ledger or other data storage structure 160, which may provide a substantially immutable record of the information associated with the token. Validity of the token and/or data indicated by the token may be verified by one or more nodes, which may trade computational and/or other verification resources for issuance of a derivative such as a tradable and/or otherwise marketable token that may be exchanged by operators of the node for financial gain. In some embodiments, one or more tokens may be traded on a marketplace platform, which will be discussed in greater detail below.

After a policy is selected by a policyholder and/or other user and the information relating to that user is verified, a smart contract may be written to establish the terms of the policy, triggers relating to the policy, and payout relating to the policy. Additional information may be included with the smart contract such as the policyholder digital ID token, historical risk data, pricing data, payout data, substantially real-time risk data, additional trigger definitions, local identification number that may be used by the server to identify a user, and/or other information that may affect the establishment and execution of a smart contract relating to the policy.

In one embodiment, the smart contract may be substantially automated in its creation and execution. For example, the server 110 may use information provided in at least some of the operations discussed above to create a policy and associate it with policyholder. This policy may be written to the distributed ledger or other data storage structure 160 such to administer the smart contract or other self-executing contract. The terms of the smart contract or other self-executing contract may be substantially immutable, as it may be verified and validated through operations of nodes associated with distributed ledger or other data storage structure 160. Triggers associated with the policy may be included by the self-executing contract such that, upon detection of such trigger, the smart contract is substantially automatically executed to provide a payout to the policyholder.

A policyholder may bind themselves to the smart contract, and therefore the policy governed by the smart contract, by accepting and/or signing the smart contract or other self-executing contract. For example, the policyholder may sign using a private key associated with the policyholders digital ID token. In another example, the policyholder may use biometric information to verify their signature and acceptance of the smart contract or other self-executing contract. Examples of biometric information may include fingerprints, retinal scans, face detection, voice detection, and/or other indications of a biometric match with a policyholder.

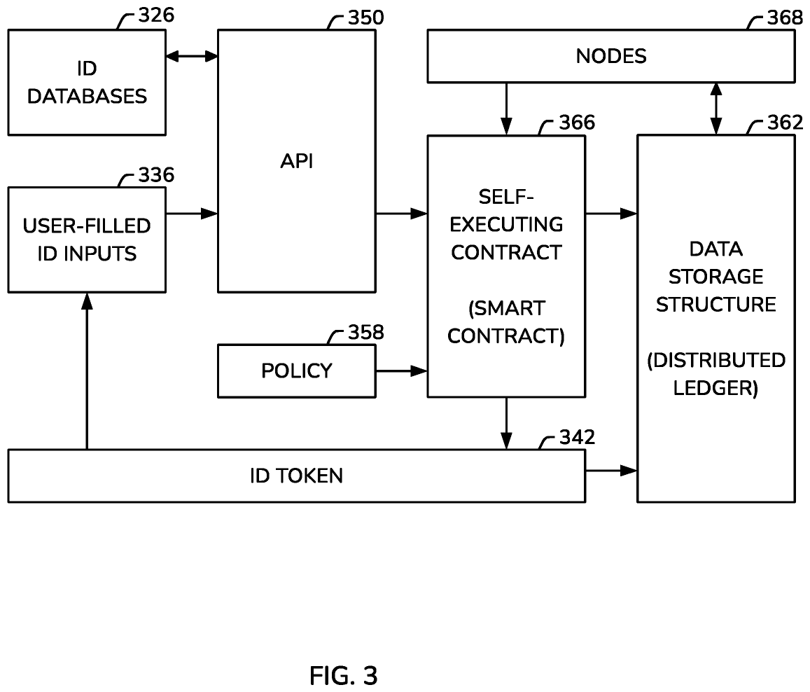

Referring now to FIG. 3, an illustrative data verification and token generation component will now be discussed, without limitation. Identification information relating to a policyholder and/or other user may be requested from ID databases 326 via an API 350. A response to the API request may be provided by the ID databases 326 via the API 350. Additionally, user-filled ID inputs 336, such as those that may be received by a user completing a survey, may be provided via the API 350. Information provided with the user filled ID inputs 336 may be associated with the identity of a policyholder and/or other user via an ID token 342.

Information retrieved via the API 350 may be used to generate and/or supplement a self-executing contract 366, which may be written to a data storage structure 362, for example and without limitation, a distributed ledger. Nodes 368 may verify and validate information included by the self-executing contract 366 and/or distributed ledger or other data storage structure 362. For example, nodes 368 may receive information from the distributed ledger or other data storage structure 362, perform calculations to validate the data, and report confirmation of validity to the distributed ledger or other data storage structure 362. If the nodes 368 detect a change in the data stored by the distributed ledger or other data storage structure 362 indicative of a trigger, the nodes 368 may indicate to the self-executing contract 366 that a claim has occurred and a payout should be disbursed. Policy information 358 may be provided to the self-executing contract 366, as may be generated in the operation discussed along with the policy recommendation component. An output from the self-executing contract 366, for example a payout event, may be associated with the policyholders ID token 342, with such event being writable to the distributed ledger or other data storage structure 362.

The payout component will now be discussed in greater detail. FIGS. 1, 4, 7, and 10-11 highlight examples of the payout component, which may also be shown in other figures. The payout component 400 may monitor substantially real-time risk data, which may be provided by substantially real-time databases and/or other sources, to determine whether a trigger has occurred and thus a payout is required according to a policy. If a trigger is detected that requires a payout, the smart contract or other self-executing contract associated with the policy may be substantially automatically executed and funds for the payout delivered to the policyholder as per the terms of the policy. A record of the payout may be kept by at least part of the server 110, which may be used for future pricing and/or training of the machine learning model.

In one embodiment, the payout component 400 may reference real-time risk data that may be retrieved from substantially real-time databases. The real-time data may include current operational status of the utility, prevalence of an infectious disease in a community, current weather events, ongoing cancellations for transportation and/or event admission, and/or other information that may relate to triggers associated with a policy. The payout component 400 of a server 110 enabled by this disclosure may perform analytics on the real-time risk data, which may include operating a machine learning model to improve prediction of a match between a trigger occurring and a payout event relating to a policy. Information used to detect occurrence of a trigger may be the identified, and anonymized, and otherwise modified to protect the identity and privacy of a policyholder.

Partnerships may be entered to access data from private or proprietary databases, such as those provided by a utility service provider and other such databases, as may be understood by a person of skill in the art after having the benefit of this disclosure. Information relating to a trigger may be stored on a distributed ledger or other data storage structure 160, which may be used to determine whether a trigger event has occurred requiring execution of the smart contract and payout of funds from the policy. In this example, information included by the distributed ledger or other data storage structure 160 may be verified, such as by nodes associated with the distributed ledger or other data storage structure 160.

If it is determined that a trigger has occurred, the payout component 400 of the server 110 may align at least part of the substantially real-time data with the smart contract associated with the policy. This alignment between a trigger occurrence and a smart contract or other self-executing contract may be assisted by operation of the machine learning model. The smart contract or other self-executing contract may then be executed, which may initiate the payout process to fund the policyholder for occurrence of the triggering event. Payment may be processed directly through the server 110, by use of a third party payment processor, through connection of a processor accessible via an API connection 150, through issuance of a derivative such as a marketable token and/or cryptocurrency, funding of a digital wallet, distribution to a charitable organization or other beneficiary designated by the policyholder, and/or by other payment distribution techniques that would be appreciated by a person of skill in the art after having the benefit of this disclosure.

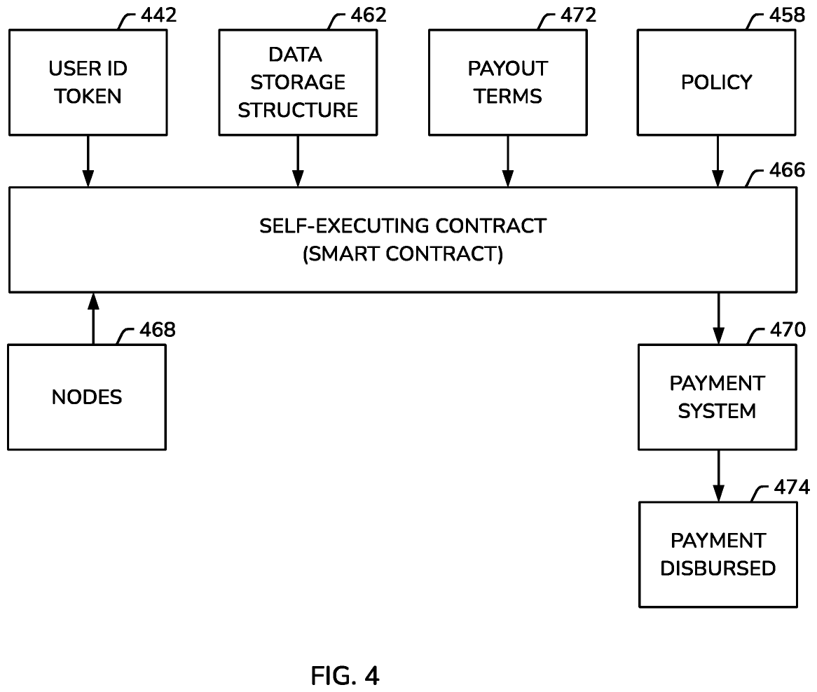

Referring now to FIG. 4, an illustrative payout component will now be discussed, without limitation. The payout component may interact with the self-executing contract 466, for example smart contract, to detect conditions indicative of a payout event, detect triggers, and assist with disbursement of payout funds to a policyholder and/or other designated beneficiaries. The self-executing contract 466 may receive information that may be used to determine whether the self-executing contract 466 should be executed, which may use smart contracts. For example, the self-executing contract 466 may receive information relating to a policyholder or user ID token 442, information included by the data storage structure 462 that may be provided by the distributed ledger, payout terms 472 to indicate which portions of funds are payable to the policyholder and/or other beneficiaries, and information relating to the policy 458. Those of skill in the art will appreciate additional sources of information may be provided to the self-executing contract 466 without limitation. Information considered by the self-executing contract 466 may be validated by nodes 468. Upon execution, the self-executing contract 466 may engage a payment system 470 to handle disbursement of the payout to the policyholder and/or other beneficiaries. The payment system 470 may facilitate payment disbursement 474 to the policyholder and/or other beneficiaries.

The incentivization token aspect will now be discussed in greater detail. FIGS. 1, 5, and 10-11 highlight examples of the incentivization token aspect, which may also be shown in other figures. Verification of information held by the distributed ledger or other data storage structure 160 may be assisted by operation of nodes to analyze and verify additions and changes made to the distributed ledger or other data storage structure 160. Nodes may be attracted to the platform, along with their computational resources, by deployment of derivatives such as incentivization tokens and/or other incentives that would be appreciated by those of skill in the art. An illustrative incentivization token may include a type of cryptocurrency dispersed to operators of the nodes in exchange for their resources to verify and validate information included by the distributed ledger or other data storage structure 160. In some embodiments, distribution of incentivization tokens may be managed and executed using smart contracts or other self-executing contracts. In some embodiments, tokens may be used as proof of purchase of a policy, which may be delivered to a policyholder's wallet. Incentivization tokens may additionally be used in some examples to allocate at least part of the payout relating to a policy as a beneficiary payout to a beneficiary such as a charity or other party.

The marketplace component will now be discussed in greater detail. FIGS. 1, 5, and 10 highlight examples of the marketplace component, which may also be shown in other figures. The marketplace component 180 may provide a platform for policyholders, users, nodes, and/or other parties to purchase, sell, trade, or otherwise engage in commerce relating to tokens associated with a system enabled by this disclosure and the methods of operating same. Tokens may be associated with individual policies, buckets of policies, payout predictions, risks, and other treatable aspects relating to a policyholder, policy, or other aspect of a coverable risk.

Tokens associated with policyholders and policies may include information that is deidentified and anonymized such that the policyholder is not identifiable by trading tokens relating to such policyholder and/or their policies. Information relating to ownership and transactions for a token may be stored on a distributed ledger or other data storage structure 160. Tokens may be minted, dispersed, treated, bought, sold, or otherwise transacted in increments of whole tokens, partial tokens, fractional tokens, divisible tokens, and/or other distributional organization of token quantities that may be marketed. Such transactions may be verified by nodes associated with the distributed ledger or other data storage structure 160, and tokens may be provided to such operators of such nodes in exchange for their computational resources and other efforts to verify the contents of the distributed ledger.

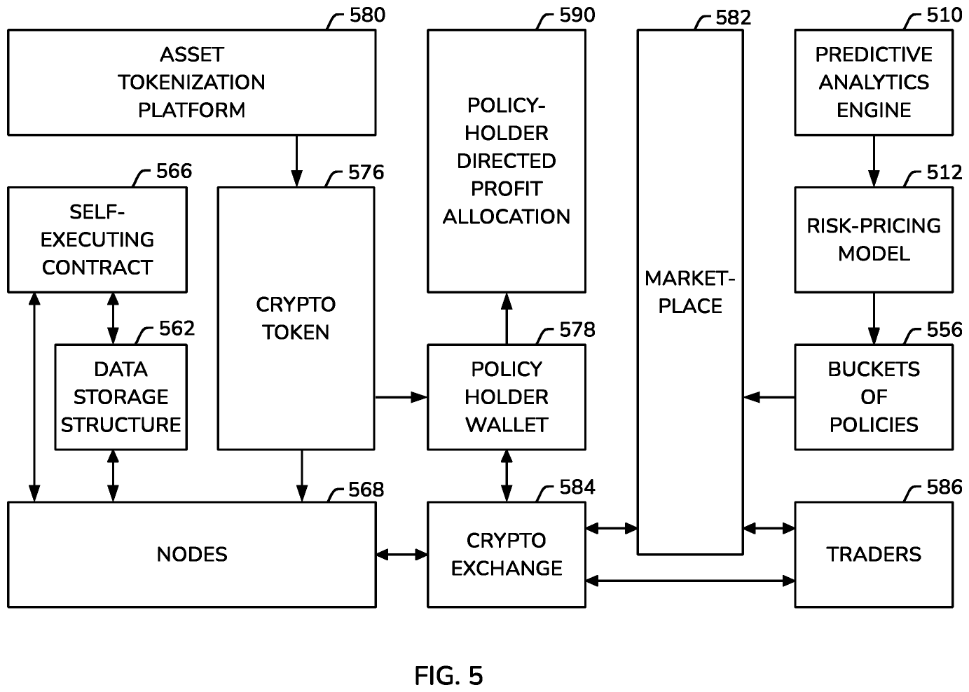

Referring now to FIG. 5, an illustrative incentivization and marketplace component will now be discussed without limitation. An asset tokenization platform 580 may generate derivative such as tradable and/or marketable tokens that may be associated with a policy, policyholder, risk, and/or other aspect relating to an insurance or risk-coverage instrument. The asset tokenization platform 580 may create a crypto token 576, which may be storable in a policyholder wallet 578. The crypto token 576 may be validated using nodes 568, which may intercommunicate with a self-executing contract 566 such as a smart contract, data storage structure 562 such as may be recorded to a distributed ledger, and/or other sources of information consistent with the scope and spirit of this disclosure. Examples of self-executing contracts 566, data storage structures 562, and nodes 568 are discussed in greater detail throughout this disclosure.

A crypto token 576 held by the policyholder wallet 578 may be dispersed to a policyholder directed profit allocation 590, which may designate the policyholder, beneficiaries, or other parties that would be apparent to a person of skill in the art after having the benefit of this disclosure. The profit allocation may include a portion of profits earned from premiums generated through users purchasing policies using a method or system enabled by this disclosure. In this example, if a profit is earned, a portion of that profit may selectively be disbursed to one or more policyholders and/or beneficiaries designated by a policy holder. Contents of the policyholder wallet 578 may also be directed to a crypto exchange 584. The nodes 568 may communicate with the crypto exchange 584 to receive and verify information held by the crypto exchange 584.

Contents provided to the crypto exchange 584 may be transacted via a marketplace 582, which may be viewed and/or transacted by traders 586. In at least one embodiment, traders 586 may also transact directly via the crypto exchange 584. The marketplace 582 may additionally receive buckets of policies 556 or other risk pools, which may be marketable with traders 586 and via a crypto exchange 584. The buckets of policies 556 or other risk pools may be defined by using contents from the risk pricing model 512, which may be defined via a predictive analytics engine 510 discussed in other examples throughout this disclosure. In some embodiments, policyholders and/or policies may be grouped in cohorts, which may at least partially be included in one or more buckets of policies 556 or other risk pools. Users, third parties, traders 586, and others may interact with the marketplace 582 to trade tokens from the policyholder wallet 578 via the crypto exchange 584, buckets of policies 556 or other risk pools, and/or another financial instrument that may be compatible with the marketplace 582.

In some embodiments, buckets of policies may be categorized by levels of riskiness. Payouts via the marketplace may be based on the execution of a smart contract, the nonexecution of a smart contract, policy expiration, risk events occurring, risk events not occurring, triggers being detected, triggers being undetected, and/or other variables that would be appreciated by skilled artisans after having the benefit of this disclosure. Participation in the marketplace may include positions taken by traders and/or other participants that are time limited with regard to whether or not a marketplace condition is met. In some embodiments, financial products may be offered through the marketplace that allows market participants to bet on an outcome, condition, trigger, risk, timeframe, and/or other metric that may be measured via a method and system enabled by this disclosure.

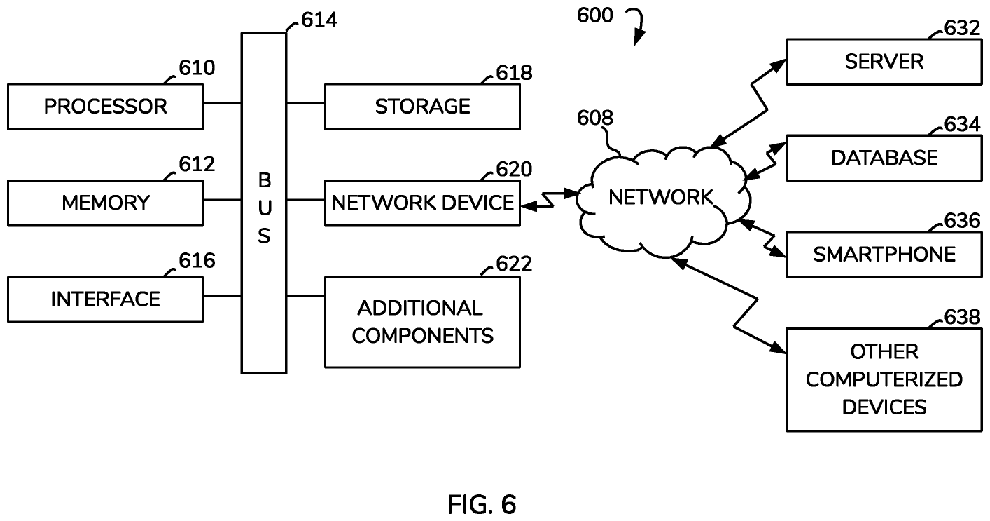

The social incentive component will now be discussed in greater detail. FIGS. 1 and 6 highlight examples of the social incentive component 190, which may also be shown in other figures. A social incentive may be offered to a policyholder to provide at least part of a policy payout to a designated beneficiary. In another embodiment, a profit allocation may be provided by the social incentive component 190 to disburse a portion of profits earned from premiums generated to one or more policyholders and/or beneficiaries designated by a policy holder. In one example, a beneficiary may include a charity or other charitable organization. In another example, a designated beneficiary may include a dependent, child, family member, or other person designated to receive a portion of the payout as a beneficiary payout. Those of skill in the art will appreciate additional types of beneficiaries that may receive at least part of the policy payout as a social incentive, which is intended to be included within the scope and spirit of this disclosure. Inclusion of a social incentive may be written by the social incentive component 190 to the distributed ledger or other data storage structure 160, which may be associated with a smart contract for the policy and/or policyholder.

If a social incentive is included, and if a trigger is detected initiating a payout from a policy, the self-executing contract may execute to disperse at least part of the payout to the designated beneficiary. The policyholder may designate a portion of the payout to be received by the beneficiary when establishing the policy, at the time of writing the self-executing contract, after establishing the policy by modification of the self-executing contract, or at another time consisted with the scope and spirit of this disclosure. If a portion of the payout is dispersed to a beneficiary, the remainder of the payout may be designated for disbursement to the policyholder. In some embodiments, multiple beneficiaries may be designated to receive portions of the payout, should a payout be initiated. In some embodiments, a portion of profits may be substantially automatically distributed to a third party and/or the policyholder as a profits payout. Should the policyholder elect to allocate a portion of profits from the premiums they pay to a third party of their choice, and should a suitable profitability threshold be met by an operator of the system, a specified amount of proceeds may be automatically disbursed to the selected third party as a profits payout according to the policy conditions, which may be defined by the self-executing contract. Excess unallocated profits or profits that are not elected by the policyholder for a profits payout may be retained without disbursement of a profits payout.

In at least one embodiment, at least part of the methods and systems enabled by this disclosure may be provided through an intermediary party. In this embodiment, aspects of an interface displayable on a user computer device may include branding provided by the intermediary party. Examples of intermediary parties may include, without limitation, licensees, contractors, subcontractors, traditional insurance providers, “white label” providers, and other parties that would be apparent to those of skill in the art after having the benefit of this disclosure. In some deployments, at least part of the server and/or databases may be operated remotely and managed by a custodian of the platform. In other deployments, at least part of a server on which the methods may be operated may be locally installed at a location of the intermediary party. Those of skill in the art will appreciate additional deployment configurations consistent with the scope and spirit of this disclosure, which are intended to be included by the disclosure without limitation.

In one embodiment, policyholders and/or other users may be able to review, monitor, and interact with their policy accounts via a dashboard accessible via a user computer device. Information may be provided to the policy holder and/or other user relating to the policy, which may differ based on coverage type. For example, information relating to an interrupted utility may include, without limitation, policy number, city, county, state, utility provider, status of service, start date, end date, tracked count, outage count, duration, outage cause, and/or other information. Those of skill in the art will appreciate additional information that may be accessible by a policyholder and/or other user via a dashboard that are related to other coverage types after having the benefit of this disclosure. Information accessible by the dashboard may additionally be used for analytics, for example, by being included in a feedback loop. Status reports, status maps, account details, special offers, social donations, other reporting metrics, support options, help documentation, payment details, and/or other information may be provided to policyholders and/or other users, for example, via the dashboard.

In some embodiments, claims may be optionally self-reported by policyholders. In these embodiments, self-reporting may be provided to allow examination of claims for events that are not detected by the triggers. A supplemental action may be initiated if a sufficient number of self-reported incidents are received. For example, provided without limitation, multiple households in a common zip code may self-report a utility outage. Upon a sufficient number of self-reporting incidents being received, an adjuster and/or investigator may be assigned to determine whether a risk event occurred even though a trigger had not been detected, determine a loss based on the risk event, determine the correlation between the actual utility outage and reporting for such outages, and/or otherwise facilitate accurate disbursement of payout funds if a qualifying event has occurred.

Referring now to FIG. 6, an illustrative computerized device will be discussed, without limitation. Various aspects and functions described in accord with the present disclosure may be implemented as hardware or software on one or more illustrative computerized devices 600 or other computerized devices. There are many examples of illustrative computerized devices 600 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 600 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 600, among others. Additionally, aspects in accord with the present disclosure may be located on a single illustrative computerized device 600 or may be distributed among one or more illustrative computerized devices 600 connected to one or more communication networks.

For example, various aspects and functions may be distributed among one or more illustrative computerized devices 600 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 6 shows a block diagram of an illustrative computerized device 600, in which various aspects and functions in accord with the present disclosure may be practiced. The illustrative computerized device 600 may include one or more illustrative computerized devices 600. The illustrative computerized devices 600 included by the illustrative computerized device may be interconnected by, and may exchange data through, a communication network 608. Data may be communicated via the illustrative computerized device using a wireless and/or wired network connection.

Network 608 may include any communication network through which illustrative computerized devices 600 may exchange data. To exchange data via network 608, systems and/or components of the illustrative computerized device 600 and the network 608 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 600 may transmit data via the network 608 using a variety of security measures including TSL, SSL, or VPN, among other security techniques. The illustrative computerized device 600 may include any number of illustrative computerized devices 600 and/or components, which may be networked using virtually any medium and communication protocol or combination of protocols.

Various aspects and functions in accord with the present disclosure may be implemented as specialized hardware or software executing in one or more illustrative computerized devices 600, including an illustrative computerized device 600 shown in FIG. 6. As depicted, the illustrative computerized device 600 may include a processor 610, memory 612, a bus 614 or other internal communication system, an input/output (I/O) interface 616, a storage system 618, and/or a network communication device 620. Additional devices 622 may be selectively connected to the computerized device via the bus 614. Processor 610, which may include one or more microprocessors or other types of controllers, can perform a series of instructions that result in manipulated data. Processor 610 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 610 may be connected to other system elements, including a memory 612, by bus 614.

The illustrative computerized device 600 may also include a network communication device 620. The network communication device 620 may receive data from other components of the computerized device to be communicated with servers 632, databases 634, smart phones 636, and/or other computerized devices 638 via a network 608. The communication of data may optionally be performed wirelessly. More specifically, without limitation, the network communication device 620 may communicate and relay information from one or more components of the illustrative computerized device 600, or other devices and/or components connected to the computerized device 600, to additional connected devices 632, 634, 636, and/or 638. Connected devices are intended to include, without limitation, data servers, additional computerized devices, mobile computing devices, smart phones, tablet computers, and other electronic devices that may communicate digitally with another device. In one example, the illustrative computerized device 600 may be used as a server to analyze and communicate data between connected devices.

The illustrative computerized device 600 may communicate with one or more connected devices via a communications network 608. The computerized device 600 may communicate over the network 608 by using its network communication device 620. More specifically, the network communication device 620 of the computerized device 600 may communicate with the network communication devices or network controllers of the connected devices. The network 608 may be, for example, the internet. As another example, the network 608 may be a WLAN. However, skilled artisans will appreciate additional networks to be included within the scope of this disclosure, such as intranets, local area networks, wide area networks, peer-to-peer networks, and various other network formats. Additionally, the illustrative computerized device 600 and/or connected devices 632, 634, 636, and/or 638 may communicate over the network 608 via a wired, wireless, or other connection, without limitation.

Memory 612 may be used for storing programs and/or data during operation of the illustrative computerized device 600. Thus, memory 612 may be a relatively high performance, volatile, random-access memory such as a dynamic random-access memory (DRAM) or static memory (SRAM). However, memory 612 may include any device for storing data, such as a disk drive or other non-volatile storage device. Various embodiments in accord with the present disclosure can organize memory 612 into particularized and, in some cases, unique structures to perform the aspects and functions of this disclosure.

Components of illustrative computerized device 600 may be coupled by an interconnection element such as bus 614. Bus 614 may include one or more physical busses (for example, busses between components that are integrated within a same machine) but may include any communication coupling between system elements including specialized or standard computing bus technologies such as USB, Thunderbolt, SATA, FireWire, IDE, SCSI, PCI, and InfiniBand. Thus, bus 614 may enable communications (for example, data and instructions) to be exchanged between system components of the illustrative computerized device 600.

The illustrative computerized device 600 also may include one or more interface devices 616 such as input devices, output devices and combination input/output devices. Interface devices 616 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 616 allow the illustrative computerized device 600 to exchange information and communicate with external entities, such as users and other systems.

Storage system 618 may include a computer readable and writeable nonvolatile storage medium in which instructions can be stored that define a program to be executed by the processor. Storage system 618 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk, or flash memory, among others. In operation, processor 610 or some other controller may cause data to be read from the nonvolatile recording medium into another memory, such as the memory 612, that allows for faster access to the information by the processor than does the storage medium included in the storage system 618. The memory may be located in storage system 618 or in memory 612. Processor 610 may manipulate the data within memory 612, and then copy the data to the medium associated with the storage system 618 after processing is completed. A variety of components may manage data movement between the medium and integrated circuit memory element and does not limit the disclosure. Further, the disclosure is not limited to a particular memory system or storage system.

Although the above-described illustrative computerized device is shown by way of example as one type of illustrative computerized device upon which various aspects and functions in accord with the present disclosure may be practiced, aspects of the disclosure are not limited to being implemented on the illustrative computerized device 600 as shown in FIG. 6. Various aspects and functions in accord with the present disclosure may be practiced on one or more computers having components other than that shown in FIG. 6. For instance, the illustrative computerized device 600 may include specially programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 600 may include an operating system that manages at least a portion of the hardware elements included in illustrative computerized device 600. A processor or controller, such as processor 610, may execute an operating system which may be, among others, an operating system, one of the above-mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together to define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface, or perform other functions). Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as a SQL Server available from Microsoft of Redmond, Wash., Oracle Database or MySQL from Oracle of Austin, Tex., or integration software such as WebSphere middleware from IBM of Armonk, N.Y.

In operation, a method may be provided for evaluating, administering, and paying out claims relating to parametric risk-coverage using distributed ledgers to reduce and/or eliminate human operation and/or administration. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

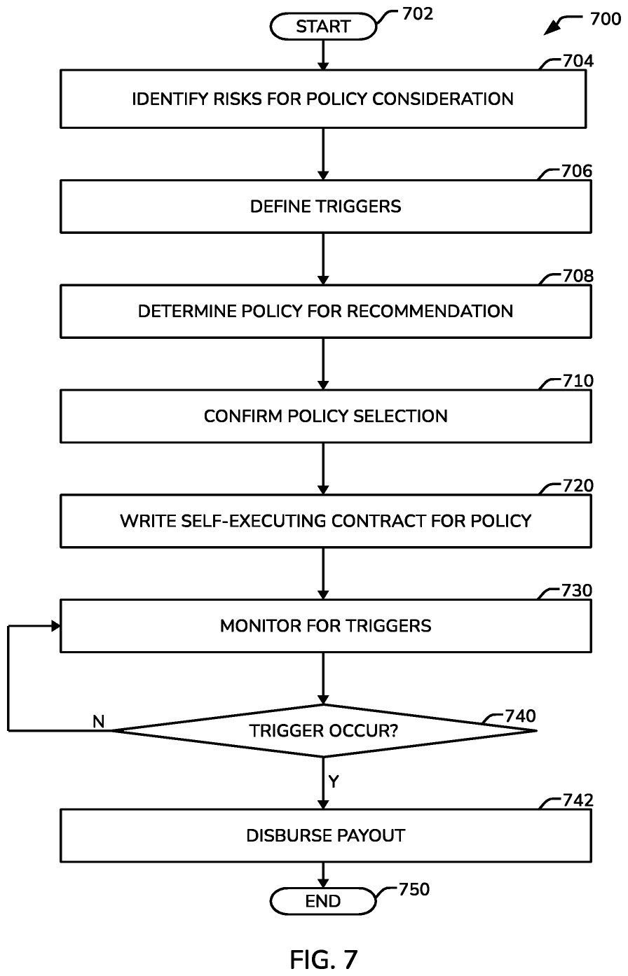

Referring now to flowchart 700 of FIG. 7, an example method for an overview of the evaluation, management, administration, payout, and other operations will be described, without limitation. Starting with Block 702, the operation may begin by identifying risks for consideration of risk coverage by a policy (Block 704). Triggers may be defined and associated with the identified risk (Block 706). The operation may then analyze the risks and triggers to determine a policy for recommendation to a policyholder (Block 708). The policyholder may then confirm policy selection (Block 710). Optionally, the policyholder may select a policy other than the one recommended at Block 708, without limitation.

Once a policy is selected, the operation may write a self-executing contract such as a smart contract for the policy (Block 720). Triggers defined in the self-executing contract may be monitored to determine whether a payout event should occur (Blocks 730). It may then be determined at Block 740 whether a trigger event has occurred. If it is determined at Block 740 that no trigger event has occurred, then the operation may return to Block 730 and continue to monitor for triggers. If it is determined at Block 740 that a trigger event has occurred, then the operation may proceed to Block 742 and disperse the payout on the policy. The operation may then end at Block 750.

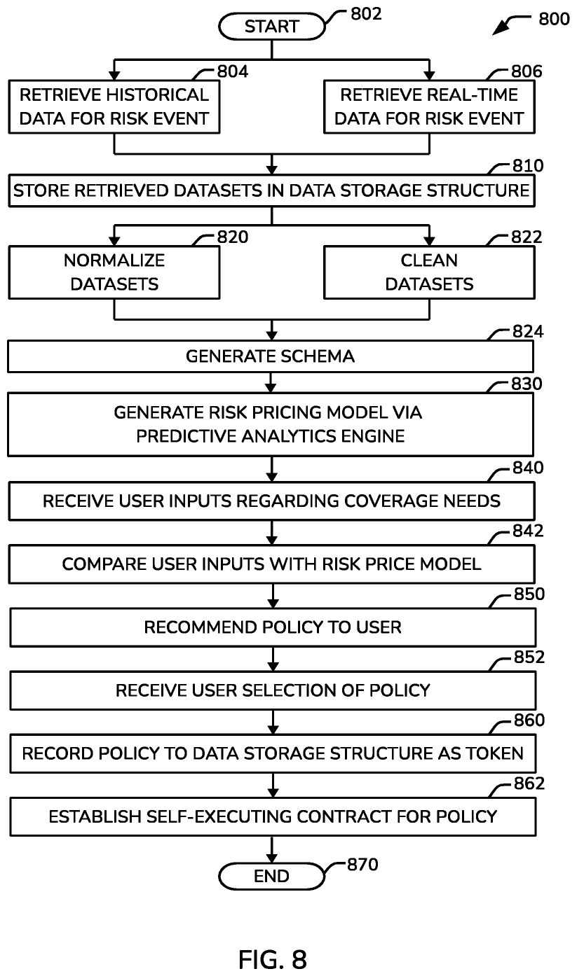

Referring now to flowchart 800 of FIG. 8, an example method for an illustrative policy recommendation and generation operation will be described, without limitation. Starting with Block 802, the operation may begin by retrieving historical data for a risk event (Block 804) and retrieving substantially real-time data for the risk event (Block 806). The operations of Block 804 and Block 806 may be operated in virtually any sequence and/or simultaneously, without limitation. Policy recommendations may leverage both historical and real-time databases to collect risk pricing data that is then stored in a distributed ledger and/or cloud platform. Once the data is retrieved for the risk event, the retrieved datasets may be stored on a data storage structure, such as may be provided by a data storage structure, such as a distributed ledger (Block 810).

The datasets may then be normalized (Block 820) and cleaned (Block 822). The operations of Block 820 and Block 822 may be performed in virtually any sequence and/or simultaneously, without limitation. In some embodiments using a distributed ledger, to record data provenance as well as to ensure data immutability, nodes may monitor the distributed ledger. Once normalized and cleaned, the datasets may be used to generate a schema (Block 824). The schema may then be used to generate a risk pricing model, for example via a predictive analytics engine (Block 830).

The operation may then receive user inputs regarding coverage needs for a policy ensuring risk events (Block 840). The user inputs may be compared with the risk pricing model (Block 842). This step of the operation may use machine learning to predict a policy that matches user inputs and information provided by the risk pricing model. For example, an AI-driven predictive analytics engine may use the resulting schema to generate a risk pricing model. In conjunction with continual inputs from the historical and real-time databases, the risk pricing model may allow the predictive analytics engine to continuously learn and refine how it assesses and prices risk. The risk pricing model may draw upon a trigger catalogue to determine when conditions have been met such that a payout should be made.

A policy may then be recommended to the user (Block 850). The user may select the policy, which may be the recommended policy and/or another policy selected by the user (Block 852). The user may additionally addon additional policy terms, coverage types, and other policy parameters when selecting a policy. The selected policy may then be recorded to the chain (Block 860). A smart contract or other self-executing contract may be established for the policy (Block 862). The operation may then end at Block 870.

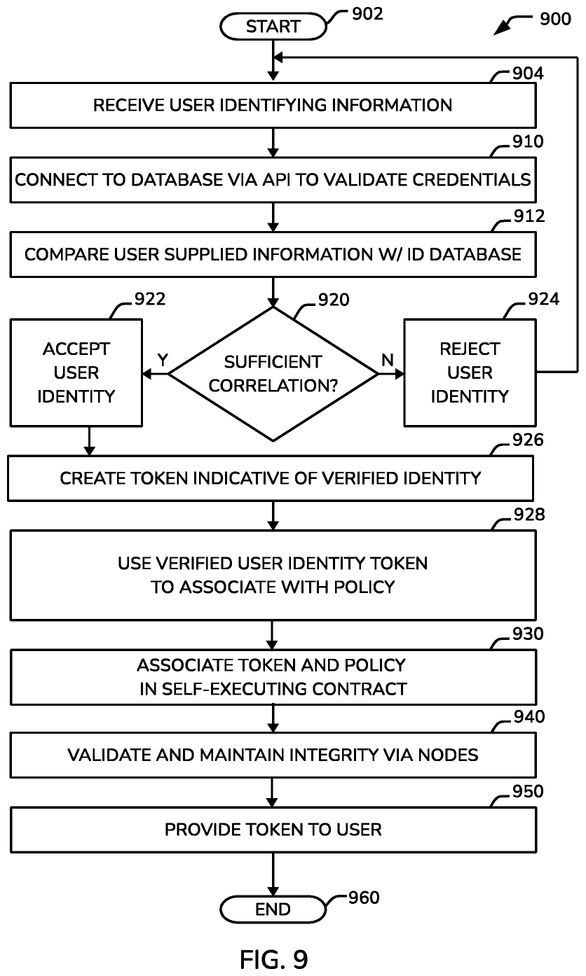

Referring now to flowchart 900 of FIG. 9, an example method for an illustrative verification and token generation will be described, without limitation. Starting with Block 902, the operation may begin by receiving user identifying information, which may be provided by the user interacting with surveys and/or other input features (Block 904). The operation may then connect to a database via an API to validate the credentials and other identifying information associated with the user (Block 910). For example, an API may be used to retrieve data from ID databases, which may include records such as DMV records, banking records, credit reports, and/or other records that would be appreciated by a person of skill in the art after having the benefit of this disclosure. The user supplied information may then be compared with the information retrieved from an ID database (Block 912). The server may cross-reference data received from the ID Databases with the user identity information such as age, date of birth, social security number, and/or other information provided by the policyholder.

It may then be determined at Block 920 whether there is sufficient correlation between the user supplied information and the information included by the ID database to validate the user. If it is determined at Block 920 that the relationship between user-supplied data and information retrieved from the ID databases insufficient to confirm the identity of the user, the user identity may be rejected (Block 924). Upon rejection, the operation may then return to Block 904 and receive new and/or supplement identifying information. An instruction may optionally be provided to a user specifying additional information requested. Alternatively, upon rejection, the operation may end at Block 960.

If it is determined at Block 920 that sufficient correlation exists, the user identity may be accepted (Block 922). A token may then be created indicative of the verified identity (Block 926). The verified user identity token may then be associated with a policy (Block 928). The token and policy may then be associated in the format of a smart contract (Block 930). The integrity of the self-executing contract and the data storage structure, for example the smart contract and distributed ledger, on which the self-executing contract is recorded may be validated and maintained using nodes (Block 940). A copy of the token may be provided to the user (Block 950). The operation may then end at Block 960.

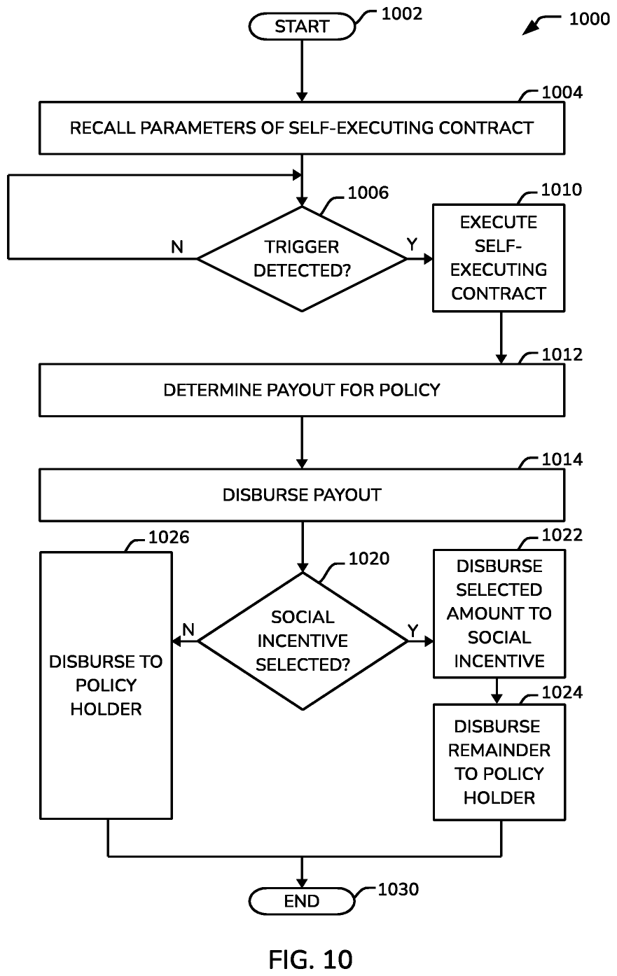

Referring now to flowchart 1000 of FIG. 10, an example method for an illustrative payout operation will be described, without limitation. Starting with Block 1002, the operation may begin by recalling parameters of the self-executing contract, such as a smart contract (Block 1004). It may then be determined at Block 1006 whether a trigger is detected. If it is determined at Block 1006 that no trigger has been detected, the operation may continue to monitor the self-executing contract for detection of a trigger. If it is determined at Block 1006 that a trigger is detected, the self-executing contract may be executed (Block 1010).

Upon execution of the self-executing contract, a payout for the policy may be determined (Block 1012). The payout may then be dispersed as defined by the self-executing contract (Block 1014). It may then be determined at Block 1020 whether a social incentive is selected. If it is determined at Block 1020 that no social incentive is selected, the full payout may be directed to the policyholder (Block 1026). If it is determined at Block 1020 that a social incentive is selected, then a portion of the payout may be dispersed to the social incentive beneficiary (Block 1022). In examples where multiple social incentives are selected, each recipient of the social incentive may receive a portion of the payout at Block 1022 as specified. The remainder of the payout may be dispersed to the policyholder (Block 1024). After the operations of either Block 1026 or 1024, the operation may end at Block 1030.

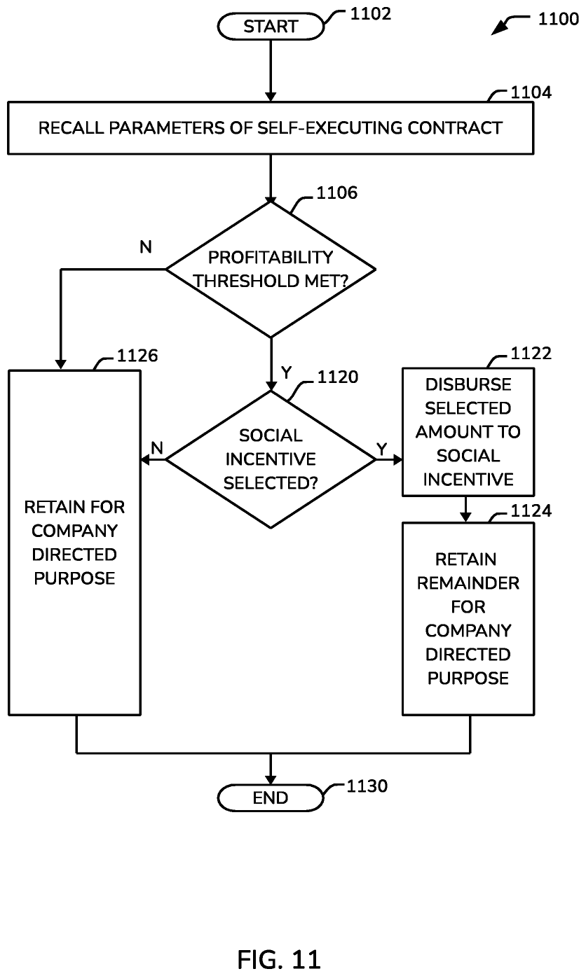

Referring now to flowchart 1100 of FIG. 11, an example method for an alternative configuration of the social incentive will now be discussed. This example may be used to replace, supplement, or otherwise be used with the example discussed above along with FIG. 10. Starting with Block 1102, the example method may begin by recalling parameters of the self-executing contract, such as a smart contract (Block 1104). It may then be determined at Block 1106 whether a profitability threshold has been met. In one example, a profitability threshold may be met if a sufficient profit is earned for operation of a system or method enabled by this disclosure.

If it is determined at Block 1106 that the profitability threshold has not been met, the operation may retain the profits, if any, to be directed for company-defined purposes (Block 1126). For example, the company operating a method or system enabled by this disclosure may reinvest the profits into the company, disburse at least part of the profits to principals of the company, donate a portion of the profits, or otherwise direct the profits as the company sees fit. Similarly, if it is determined that an insufficient profit has been earned, the operation may elect not to disburse a profits payout.

If it is determined at Block 1106 that a profitability threshold has been met, the operation may continue to Block 1120 and determine whether a social incentive has been selected by the policyholder. If it is determined at Block 1120 that no social incentive has been selected by the policyholder, the operation may continue to Block 1126 and retain profits for company directed purposes. If it is determined at Block 1126 that the policyholder has designated a social incentive to receive at least part of the profits payout, a selected amount of the profits may be disbursed as a profits payout to the designated beneficiary (Block 1122). Beneficiaries may include charitable organizations, family, the policyholder, and/or other parties. If a beneficiary is designated, a portion of profits may be substantially automatically disbursed to a third party or the policyholder. The remainder of the profits that are not disbursed as a profits payout may be retained by the company operating a method or system enabled by this disclosure to allocate as the company sees fit (Block 1124). After the operation of Block 1126 or Block 1124, the operation may end at Block 1130.

An example method for an illustrative token incentivization and marketplace operation will be described, without limitation. The operation may begin by leveraging an asset tokenization platform to create a crypto utility token. This crypto token may be secured and monitored by third party nodes, which may also monitor and secure the distributed ledger and/or smart contracts recorded to the distributed ledger. Nodes may receive at least part of a token as a reward for securing and monitoring the distributed ledger and/or smart contracts.

The nodes may also facilitate transmission of the token to policyholder wallets so that policyholders may direct how they would like to allocate profit to social incentives. Third party nodes, as well as policyholders, may also choose to trade the utility tokens they receive on third party crypto exchanges, should those exchanges choose to list the token. Traders may also participate in trading tokens and other assets by acquiring tokens via third party exchanges.

In addition, nodes, policyholders, and traders may use tokens to trade derivatives. Buckets of policies assorted by riskiness may be created via the predictive analytics engine and/or risk-pricing model. In one example, buckets of policies may be tradeable as derivatives. In another example, financial instruments based on policies, tokens, buckets of policies, risks, or other metrics associated with a policy may be listed on public trading exchanges.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A method of administering a policy of parametric risk-coverage, the method being operable on a server storing user information about a user in an electronic computer database, the method comprising:
(a) retrieving datasets via a computer communications network operatively connected to the server via a network connection, the datasets comprising risk information relating to a risk that is coverable;
(b) pricing a claim relating to the risk by analyzing the datasets to model a likelihood of claim relating to the risk and determining a preliminary risk price for the risk based on the at least the likelihood of claim and a cost for the claim;
(c) defining triggers associated with the risk determinative of when a payout associated with the claim to which the triggers apply will be disbursed, the triggers being storable in a trigger catalogue;
(d) recommending the policy for the risk comprising:
i. displaying on a user's remote computing device a survey regarding the risk for which the policy is requested,
ii. comparing survey results from the survey with the risk information to determine if the risk is coverable,
iii. for the risk that is coverable, adjusting the preliminary risk price to determine a policy risk price and recommending the policy at the policy risk price;
(e) establishing the policy, further comprising:
i. receiving via the computer communications network a selection by the user of the policy,
ii. for the policy selected by the user, recording the policy to a data storage structure and writing a self-executing contract to define the triggers that will cause the claim on the policy; and
(f) monitoring for occurrence of the triggers defined by the self-executing contract and, upon detection of the occurrence of the triggers, disbursing the payout by performing the steps comprising:
i. substantially automatically executing the self-executing contract,
ii. substantially automatically disbursing funds for the payout defined by the self-executing contract to the user, and
iii. recording the disbursement to the data storage structure.

2. The method of claim 1, wherein the datasets comprise historical datasets and substantially real-time datasets.

3. The method of claim 1, wherein step (a) further comprises:
i. normalizing at least part of the datasets to promote comparative analysis of the risk information included in the datasets that are normalized; and
ii. cleaning the datasets to generate a schema to assist with analyzing the datasets.

4. The method of claim 3, wherein step (b) further comprises:
generating data models using the schema and the datasets via a machine learning model and/or predictive analytics engine;
wherein the datasets comprise historical datasets and substantially real-time datasets; and
wherein the data models comprise a risk pricing model.

5. The method of claim 4, further comprising:
(g) verifying the data models generated by the machine learning model and/or the predictive analytics engine and validating at least the policy and the self-executing contract recorded to the data storage structure using nodes.

6. The method of claim 5, further comprising:
(h) generating an incentivization token that is associated with the policy and recorded to the data storage structure.

7. The method of claim 1, further comprising:
retrieving verification information via the computer communications network relating to the user;
using the machine learning model that is trained, comparing the user information provided by the user with the verification information to determine a likelihood of verification of the user.

8. The method of claim 1:
wherein the data storage structure comprises a distributed ledger;
wherein the self-executing contract comprises a smart contract; and
wherein at least the policy and the smart contract are recorded to the distributed ledger and made immutable.

9. The method of claim 1, further comprising:
(i) providing trading of derivatives relating to the policy and/or a bucket of policies via a marketplace;
wherein the bucket of policies is represented by a utility token that is tradeable via the marketplace; and
wherein activity of the utility token that is traded is recorded to the data storage structure.

10. The method of claim 1, further comprising:
(j) selectively providing a beneficiary payout from at least part of the payout when elected by the user as social incentives, further comprising:
i. upon execution of the self-executing contract for the payout with the beneficiary payout being elected, directing at least part of the payout as the beneficiary payout; and
ii. directing at least part of a remaining portion of the payout for disbursement to the user.

11. A system to administer a policy of parametric risk-coverage, the system comprising:
a server storing user information about a user in an electronic computer database;
a network connection, from the server, to a computer communications network;
wherein the server is configured to execute instructions that perform:
(a) retrieving datasets via the computer communications network comprising risk information relating to a risk that is coverable;
(b) pricing a claim relating to the risk by analyzing the datasets via the server to model a likelihood of claim relating to the risk and determining a preliminary risk price for the risk based on the at least the likelihood of claim and a cost for the claim;
(c) defining triggers associated with the risk determinative of when a payout associated with the claim to which the triggers apply will be disbursed;
(d) recommending the policy for the risk comprising:
i. displaying on a user's remote computing device a survey regarding the risk for which the policy is requested,
ii. comparing survey results from the survey with the risk information to determine if the risk is coverable,
iii. for the risk that is coverable, adjusting the preliminary risk price to determine a policy risk price and recommending the policy at the policy risk price;
(e) establishing the policy, further comprising:
i. receiving via the computer communications network a selection by the user of the policy,
ii. for the policy selected by the user, recording the policy to a distributed ledger and writing a smart contract to define the triggers that will cause the claim on the policy; and
(f) monitoring for occurrence of the triggers defined by the smart contract and, upon detection of the occurrence of the triggers, disbursing the payout by performing the steps comprising:
i. substantially automatically executing the smart contract,
ii. substantially automatically disbursing funds for the payout defined by the smart contract to the user, and
iii. recording the disbursement to the distributed ledger.

12. The system of claim 11, wherein the datasets comprise historical datasets and substantially real-time datasets.

13. The system of claim 11, wherein:
at least part of the datasets is normalized to promote comparative analysis of the risk information included in the datasets that are normalized, and
cleaning the datasets to generate a schema to assist with analyzing the datasets.

14. The system of claim 13, further comprising:
a machine learning model and/or predictive analytics engine to generate data models using the schema and the datasets;
wherein the datasets comprise historical datasets and substantially real-time datasets; and
wherein the data models comprise a risk pricing model.

15. The system of claim 14, further comprising:
nodes to verify the data models generated by the machine learning model and/or the predictive analytics engine and validate at least the policy and the smart contract recorded to the distributed ledger.

16. The system of claim 15, wherein an incentivization token is generated and associated with the policy recorded to the distributed ledger.

17. The system of claim 11, further comprising:
a trigger catalogue stored in the electronic computer database and accessible by the server to store the triggers.

18. The system of claim 11, wherein at least the policy and the smart contract are recorded to the distributed ledger and made immutable.

19. The system of claim 11, further comprising:
a marketplace component that provides trading of derivatives relating to the policy and/or a bucket of policies;
wherein the bucket of policies is represented by a utility token that is tradeable via the marketplace component; and
wherein activity of the utility token that is traded is recorded to the distributed ledger.

20. The system of claim 11, further comprising:
a social incentives component that selectively provides a profits payout from at least part of profits; and
wherein the user selectively directs at least part of the profits payout as a beneficiary payout, wherein any remaining portion of the profits payout are disbursed to the user or retained by an operator of the system.
